(19) United States
(12) Patent Application Publication
(10) Pub. No.: US 2012/0128406 A1
(43) Pub. Date: May 24, 2012

(54) Set for Fastening of Measuring Device, particularly Rangefinder, to Monitored Element of Building Construction, especially of the roof, Fastening Method of Measuring Device Using Such Set and Suspension for Fastening of Measuring Device

(75) Inventors: Zbigniew Pioro, Warszawa (PL); Jakub Jasinski, Andrespol (PL); Marcin Osiniak, Warszawa (PL)

(73) Assignee: WISENE SP. Z.O.O, Warszawa (PL)

(21) Appl. No.: 13/205,075

(22) Filed: Aug. 8, 2011

(30) Foreign Application Priority Data
Nov. 18, 2010 (PL) P 392968

(51) Int. Cl. F16C 11/04; B23P 11/00

(52) U.S. Cl. 403/113; 29/428

(57) ABSTRACT

The invention relates to the set for fastening of measuring device, particularly rangefinder, to the monitored element of building construction, especially of the roof, which includes an universal joint (1) and at least two fluidic dampers (2, 3) and an outer end (6) of the first shaft (4) of an universal joint is equipped with technical means for rigid connection to building construction element while an outer end (7) of the second shaft (5) is equipped with technical means for rigid connection to measuring device, and dampers are equipped at their both ends with technical means for swinging connection of these ends to building construction element or to the measuring device or to an universal joint shafts. The invention relates also to the fastening method of measuring device by means of a fastening set and suspension containing a fastening set.

### BACKGROUND OF THE INVENTION

The subject of the invention is a set for fastening of measuring device, particularly rangefinder, to monitored element of building construction, especially of the roof, fastening method of measuring device by means of such set and suspension for measuring device fastening.

Due to the safety reasons it is necessary to monitor many physical quantities in buildings including vertical displacement of building construction elements, especially the roof construction elements or their parts. It can be realized for example by calculating the difference between current value of distance of these elements from stable construction elements or stable floor and an initial value of this distance determined during monitoring initiation. Current value of distance can be measured for example by laser rangefinder fastened directly to these elements by means of various kind of suspensions.

Patent application P-385572 presents the device for monitoring deflection of building construction elements, especially of the roofs, under extreme loads including snow and icing. The device contains laser rangefinder and is integrated with the construction element, which is subject to deformation. The device has an outer housing in cylindrical shape, whose base is equipped with a mounting connector for rigid mounting of outer housing to monitored construction element and its lower part is equipped with lower diaphragm with a hole located in the middle. In this solution a rigid mounting of housing to the elements of building construction was used. The measuring device is placed inside of outer housing and is suspended by means of at least one flexible and inextensible suspension.

In the subject literature specialized methods of hanging/fastening of measuring device are not found.

There are known simple methods of fastening of the measuring device equipped with a rangefinder by means of a sling-adequate lug hung on a hook mounted to the monitored element of roof construction. This solution is beneficial because it is swinging and inextensible; it ensures gravitational stabilization of position of rangefinder optical axis, however, the time to return to its original resting position (free oscillation time) is rather very long. It results from small dissipation factor of kinetic energy due to low friction of a sling and very low resistance of the air.

There are a few problem with fastening of the measuring device to the monitored element of building construction. Monitored elements may be deflected, twisted and displaced in small range. Transient forces inducing vibrations may also act on monitored construction elements. Lateral forces, caused by e.g. air blasts or drafts, may also act on rangefinders fastened to construction elements.

Laser rangefinder should be fastened to construction elements in such a manner, that, in the above-mentioned circumstances, the determination of the vertical displacement of a construction element in the rangefinder's fastening point, realized by the calculation of a difference between measured value of the distance of this element from stable construction elements or stable floor and an initial value of this distance measured during the monitoring initiation, gives accurate results. Laser rangefinder should return to its original position fast and precisely after temporary swaying it from equilibrium position, which may occur in result of e.g. blow, shock or air blasts.

### SUMMARY OF THE INVENTION

According to the invention, the set for fastening of measuring device, particularly rangefinder, to the monitored element of building construction, especially of the roof, includes an universal joint and at least two fluidic dampers, and an outer end of the first shaft of an universal joint is equipped with technical means for rigid connection to building construction element, while an outer end of the second shaft is equipped with technical means for rigid connection to measuring device, and dampers are equipped at their both ends with technical means for swinging connection of these ends to building construction element or to measuring device or to an universal joint shafts.

It is beneficial when technical means for swinging connection are ball joints.

The subject of the invention is also a fastening method of measuring device, particularly rangefinder, to the monitored building construction element, especially of the roof, by means of a fastening set, wherein an universal joint having technical means for rigid connection at shaft outer ends, is mounted directly or by means of an additional rigid linkage elements to the building construction by outer end of the first shaft and outer end of the second shaft directly or by rigid linkage elements to the measuring device, and dampers, equipped at their ends with technical means for their swinging connection, are mounted in such a way that the first end is fastened to the building construction element directly or by means of a rigid linkage element and the second end is fastened also directly or by means of a rigid linkage element, to the measuring device, and dampers are fastened in such a way that structural axes of dampers and the joint are not located on the same plane.

The subject of the invention is also a suspension containing set for fastening of measuring device, particularly rangefinder, to the monitored element of building construction, especially of the roof, which includes an universal joint and at least two fluidic dampers; an outer end of the first shaft of an universal joint is equipped with technical means for rigid connection to building construction element while an outer end of the second shaft is equipped with technical means for rigid connection to measuring device, dampers are connected by swinging connection to joint shafts of joint by technical means located at damper ends for their swinging connection, and dampers are located in such a position that structural axes of dampers and the joint are not located on the same plane.

It is beneficial when dampers are swinging connected to shafts of an universal joint by rigid arms, with which shafts are equipped.

It is beneficial when technical means for swinging connection are ball joints.

It is also beneficial when rigid arms are equipped with technical means for interaction with the means for swinging connection of dampers, it is beneficial if the ends are equipped with balls while rigid arms—with pans.

In the solution, according to the invention, an universal joint is an universal coupling, Cardan joint or Hook joint. Ball joints are technical means for swinging connections.

### BRIEF DESCRIPTION OF THE DRAWINGS

The subject of the invention is shown as an example on the drawing, on which:

FIG. 1 shows fastening set,

FIGS. 2A and 2B show fastening of measuring device using a set shown in FIG. 1, and FIG. 2A shows fastening of measuring device to an construction element in form of a beam, FIG. 2B—to any element, and

FIG. 3 shows suspension containing a set presented in FIG. 1.

### DESCRIPTION OF A PREFERRED EMBODIMENT

The set for fastening of measuring device includes an universal joint 1 (e.g. Cardan joint or Hook joint) and at least two fluidic dampers 2, 3; an outer end 6 of the first shaft 4 of the joint is equipped with technical means for its rigid connection to building construction element and an outer end 7 of the second shaft 5 is equipped with technical means for its rigid connection to the measuring device. Dampers 2, 3 at the ends are provided with technical means, preferably ball joints 9, for swinging connection of these ends to building construction element or to the measuring device or to an universal joint shafts. Every ball joint consists of ball 9′, with which an element is equipped, to which damper is fastened and co-operating pan 9″, with which damper is equipped at each end. Damper from a set may be mounted to an rigid arm 8 or to a rigid linkage element 12.

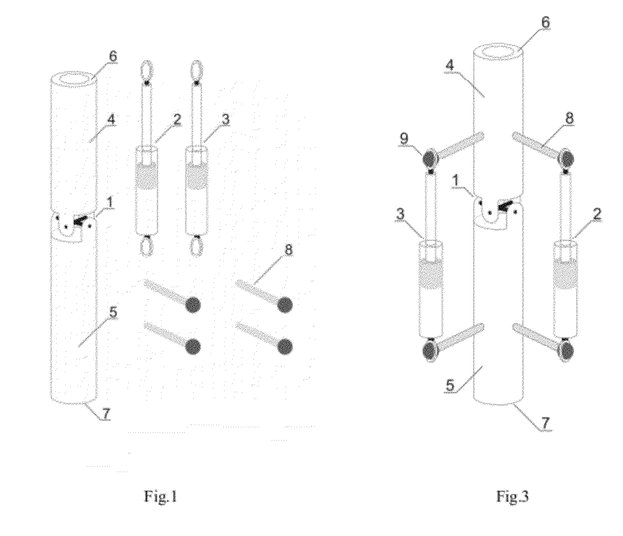

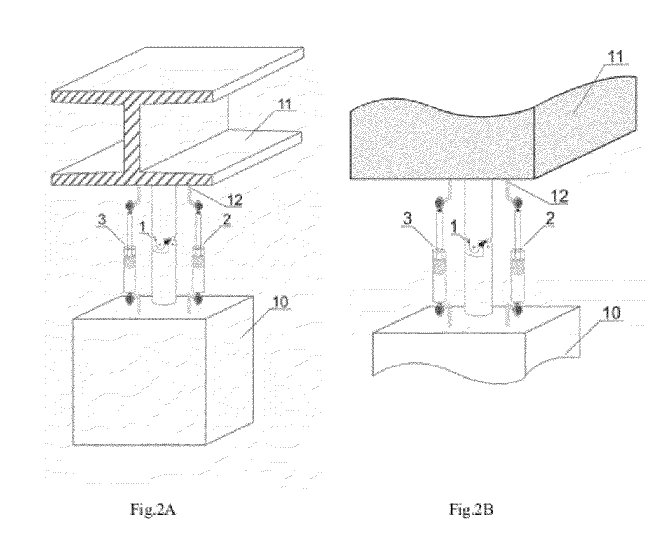

FIG. 2A shows an example of fastening of measuring device 10 to building construction element, e.g. beam 11, using the set shown in FIG. 1.

The suspension contains an universal joint 1, and at least two fluidic dampers 2, 3; an outer end 6 of the first shaft 4 of an universal joint is equipped with technical means for its rigid connection to building construction element and outer end 7 of the second shaft 5 of an universal joint is equipped with technical means for its rigid connection to the measuring device. Dampers 2, 3 at the ends are provided with technical means, preferably ball joints 9, for swinging connection of these ends to rigid arms 8, with which an universal joint shafts are equipped. Such suspension is shown in FIG. 3.

The set and the suspension, according to the invention, ensure minimization of distance measuring errors during monitoring of vertical displacement of building construction elements by ensuring fast and precise return of measuring device (e.g. a rangefinder) to its original position after transient deflection from equilibrium position. An universal joint enables free movements of measuring device and its return to a position of minimal potential energy (lowest possible position of center gravity). Swingingly mounted dampers with high dynamic friction and low static friction ensure of damping of measuring device movements and reduce the return time to the initial position. The use of the set and suspension, according to the invention, gives swinging and inextensible suspension with embedded oscillation damping, i.e. with high dissipation of kinetic energy of suspended body.

Dampers used in the solutions, according to the invention, are piston, fluidic dampers with fluid like oil or air.

According to the invention, the fastening set or suspension is used for fastening of measuring device in any form with a enclosure of free shape, preferably rectangular prism, cylinder or ball.

The set, according to the invention, may consist of an universal joint and at least two dampers and one or two or all these elements are fastened directly to the monitored element of building construction and directly to the measuring device. There are also possible other variants of fastening the set, according to the invention. Only lower ends of a joint and dampers, that is ends fastened to the measuring device, are fastened directly and opposite ends of dampers and joint are fastened directly to the elements of building construction, e.g. through rigid linkage elements. Rigid linkage elements may be mounted on an universal joint, i.e. joint is equipped with rigid linkage elements (e.g. rigid arms), to which dampers ends are fastened or rigid linkage element (elements) are a separate element, to which dampers ends and joint ends are mounted. Then such rigid linkage element is fastened to building construction element. In other words, dampers are mounted in a free way which ensures of damping of an universal joint free movements. Dampers are mounted in such a way, that structural axes of dampers and the joint are not located on the same plane.

Elements of the set, according to the invention, may be connected directly or indirectly using additional rigid linkage elements.

In exemplary embodiment of invention, shown in FIG. 3, both damper ends are mounted to rigid linkage elements in from of rigid arms, with which an universal joint is equipped. So only an universal joint is mounted to the monitored element of building construction at first end and at the opposite end to the measuring device. Connection of the joint to the mentioned elements may or may not be direct.

What is claimed is:

1. The set for fastening of measuring device, particularly rangefinder, to the monitored element of building construction, especially of the roof, according to the invention, includes an universal joint (1) and at least two fluidic dampers (2, 3), and an outer end (6) of the first shaft (4) of an universal joint is equipped with technical means for rigid connection to building construction element, while an outer end (7) of the second shaft (5) is equipped with technical means for rigid connection to measuring device, and dampers are equipped at their both ends with technical means for swinging connection of these ends to building construction element or to measuring device or to an universal joint shafts.

2. The set for fastening of measuring device according to claim 1, wherein the technical means for swinging connection are ball joints.

3. The fastening method of measuring device, particularly rangefinder, to the monitored building construction element, especially of the roof, by means of a fastening set, wherein an universal joint (1) having technical means for rigid connection at shaft outer ends is mounted directly or by means of an additional rigid linkage elements to the building construction by outer end (6) of the first shaft (4) and outer end (7) of the second shaft (5) directly or by rigid linkage elements to the measuring device, and dampers (2, 3), equipped at their ends with technical means for their swinging connection, are mounted in such a way that the first end is fastened to the building construction element directly or by means of a rigid linkage element and the second end is fastened also directly or by means of a rigid linkage element, to the measuring device, and dampers are fastened in such a way that structural axes of dampers and the joint are not located on the same plane.

4. The suspension containing set for fastening of measuring device, particularly rangefinder, to the monitored element of building construction, especially of the roof, according to the invention, includes an universal joint (1) and at least two fluidic dampers (2, 3); an outer end (6) of the first shaft (4) of an universal joint is equipped with technical means for rigid connection to building construction element while an outer end (7) of the second shaft (5) is equipped with technical means for rigid connection to the measuring device, dampers (2, 3) are connected by swinging connection to joint shafts (4, 5) of joint (1) by technical means located at damper ends for their swinging connection, and dampers (2, 3) are located in such a position that structural axes of dampers (2, 3) and the joint (1) are not located on the same plane.

5. The suspension containing set for fastening of measuring device according to claim 5, wherein dampers (2, 3) are swinging connected to shafts (4, 5) of an universal joint (1) by rigid arms (8), with which shafts (4, 5) are equipped.

6. The suspension containing set for fastening of measuring device according to claim 5, wherein technical means for swinging connection are ball joints (9).

7. The suspension containing set for fastening of measuring device according to claim 6, wherein rigid arms (8) are equipped with technical means for interaction with the means for swinging connection of dampers (2, 3), it is beneficial if the ends are equipped with balls (9′) while rigid arms (8)—with pans (9″).
